(19) United States
(12) Patent Application Publication
(10) Pub. No.: US 2008/0307663 A1
(43) Pub. Date: Dec. 18, 2008

(54) Method and apparatus for marking tile for cutting

(76) Inventor: Stephen H. Peterson, Apache Junction, AZ (US)

Correspondence Address: BOOTH UDALL, PLC, 1155 W. Rio Salado Pkwy., Suite 101, Tempe, AZ, 85281, US

(21) Appl. No.: 11/764,090

(22) Filed: Jun. 15, 2007

(51) Int. Cl. G01B 1/00

(52) U.S. Cl. 33/527

(57) ABSTRACT

A method and apparatus for marking near perfect cut lines during the tile setting process in a manner that is cost effective and efficient because it conforms with the unique contours and characteristics of fixed structures such as walls and cabinets while significantly reducing the amount time and wasted tiles due to its user friendly method of gleaning exact cut lines.

### FIELD OF THE INVENTION

The present invention is a method and apparatus for marking nearly perfect cut lines during the tile setting and cutting process. The present invention consists of a sturdy material in communication with an extension element that slides inward and outward through the use of a wing nut, locking mechanism and connection points.

### BACKGROUND OF THE PRESENT INVENTION

One of the greatest investments many people make is often their home. Significant amounts of money are spent every day to ensure that the home is fixed up as best as can be within the confines of varying budgets. One of the most common areas of home repair and maintenance rests with the flooring. Whether it is a home or business facility, a properly laid floor is a necessity in terms of property value, aesthetics and safety. Specifically with tile flooring, it is detrimental that the tile be set with the highest level of proper workmanship.

Shoddy workmanship in relation to setting tile often correlates with the measuring and cutting process. Although it is relatively simple to set tile flooring in the middle of a room, it is a much more involved process when it comes to setting tile adjacent to fixed structures such as walls and cabinets. If the tile is not measured properly, then it will likely not be cut properly and the prospect exists that the tile will ultimately be set improperly. If that happens, then the tile will not look aesthetically pleasing because the tile will be uneven in relation to the abutting fixed structure. In addition, the resulting gap from an improperly measured and cut tile can result in such negative issues as increased moisture collection and mold. The best-case scenario when tile is measured and cut improperly is that the particular piece of tile will be thrown away and a new piece of tile will be measured and cut. This, of course, can be costly and time consuming as measurements must be taken and retaken for various pieces of tile.

The reason tile must be measured or otherwise marked for cutting before being cut is because fixed structures often are not even at the point where they meet the floor. This means that a cabinet or wall may not be perfectly constructed. Because of this common reality, those who set tile flooring must cater the individual tiles to meet the fixed structure based on the construction of that fixed structure. Measuring, marking and cutting tile to follow the unpredictable contours of a wall or other fixed structure is key to a properly set tile floor. It is no coincidence then that this aspect of setting a tile floor is the most time consuming and difficult part of the process.

The most common method used to measure the contours of a fixed structure is with the use of a tape measure. Tape measures require the user to attempt to line the tape element of that tool to ultimately make an exact measurement relating to the contours of the fixed structure. A major downside of the tape measure for this use is that tape measures often are flimsy and difficult to glean exact measurements when used in such confined areas.

This is especially true when attempting to mark each little contour between the fixed structure and the incoming grout line. Each contour can have slight variations, which make the tape measure process tedious, time consuming and rife with error. Even if a tape measure is off by 1/16″, the cut of the tile may not conform to the contour of the fixed structure.

The tape measure approach also has inherent flaws in regard to how one reads the tape. Many times, the top of the tile may match up to the contours of the fixed structure, but the bottom will not. This tapered cut will appear shoddy, as the tile will not quite line up to the baseboard of the permanent structure. In addition to the uneven cuts, tape measures also become rusty over relatively short periods of time when heavily used. When the tape measure's condition deteriorates, the rust and other issues cause it to function with less mobility, which also affects the measurement process. An additional element is that tape measures must be read. However uncommon it may be, some people may not be able to read the numbers provided on some tape measures whether it is from physical issues or illiteracy.

Because of these issues, there is a substantial need for a user-friendly method and apparatus that can serve to provide near-perfect cut lines on tile that will ultimately be cut and placed next to fixed structures. A user-friendly and cost-efficient method and apparatus will save significant amounts of time and cost if, like the present invention, it can use a locking mechanism to set a conforming distance in place rather than mere tiny measurements.

U.S. Pat. No. 5,617,642 issued to Marios on Apr. 8, 1997 is a tile fitting method and device that uses various aspects of its design, including base plates and rods, to provide cut lines on various building materials in mostly mosaic patterns. Unlike the present invention, Marios uses a number of moveable parts and relies on multiple base plates and multiple extension rods to determine mosaic patterns rather than the relatively simple and user-friendly apparatus of the present invention in determining cut lines during the tile setting process.

U.S. Pat. No. 5,701,680 issued to Garcia et al on Dec. 30, 1997, is a tile setter's measuring tool that employs four dowels arranged in a V-shaped pattern and a cup slide connected to an object guide. Unlike the present invention, Garcia employs a number of moveable parts and performs additional, complicated steps in respect to grout line spacing and measurement.

U.S. Pat. No. 6,536,125 issued to Klapperich on Mar. 25, 2003, is a tool for measuring and shifting squares that consists of rotating screws and rails. Unlike the present invention, Klapperich employs a number of moveable parts that does not compare with the user-friendly and cost-efficient elements of the present invention. Klapperich employs a significantly more complicated array of grooves, rails and rotatable elements that must be slid and moved into various grooves in order to function.

U.S. Pat. No. 6,973,736 issued to Garcia on Dec. 13, 2005, is a tile contour tool that uses multiple parts to ultimately allow for a user to trace contours onto tile for cutting. Unlike the present invention, Garcia employs a tracing method where various slots, pivots and extensions are used to communicate with each other at specific angles in order to complete the contour tracing function.

There is no question that there is a significant need for an alternative to standard measuring devices in regard to the tile cutting process. However, the need remains for a cost-effective and user-friendly apparatus, such as the present invention, where the movable parts are kept to a minimum while the effective results are achieved. Whether it is amateur do-it-yourselfers or professional tile setters, the present invention satisfies the need for a user friendly method and apparatus designed to properly and accurately mark cut lines on tile that is being set near fixed structures.

### SUMMARY OF THE PRESENT INVENTION

The present invention is a tile cutting apparatus that is user friendly in that it does not contain multiple moveable parts. The present invention is made of a sturdy material that does not rust. An example of an embodiment of the present invention in terms of material is a sturdily constructed plastic apparatus. A wing nut extends through the body of the present invention. The wing nut can be tightened in order to lock the extension element of the present invention in place. The wing nut also can be loosened in a conventional manner when it becomes time to move the present invention. The extension element of the present invention can extend from the end of the body of the present invention out to a useful distance beyond the body of the present invention.

The present invention is a tool that aids a user in measuring accurate lines when it becomes necessary to cut tile in order to set the tile in an aesthetically pleasing and proper manner. The present invention is especially useful when tile must be cut to fit between the already set tile and a fixed structure such as a wall or cabinet. The locking of the extension function through the use of the wing nut permits the user to utilize the present invention to account and adapt to the condition and unique deficiencies of virtually any fixed structure.

The method of the present invention begins with the user placing two pieces of like tile flat onto a table next to each other. A spacer to account for the grout line is placed between the tiles. The apparatus of the present invention then becomes engaged in the method. The wing nut is conventionally loosened in order to move the extension element. The extension element is extended so that one end of the apparatus is lined up with the edge of the tile and the extension element is lined up with the outside edge of the grout line. The wing nut is conventionally tightened which locks the extension in place. This also serves to effectively set the apparatus for use.

The present invention pertains to virtually all types of measuring and cuts, including straight, diagonal and offset. Once the apparatus is locked into place, the user will place an uncut tile on top of an existing uncut tile. The existing uncut tile is the one that is in front of the cut area and already set. The user must ensure that the uncut tile is resting exactly over the existing uncut tile with all edges lined up. The rear end of the apparatus is lined up against the fixed structure. The user will then mark the point at an edge of the uncut tile where the extension element edge is located and then use a conventional writing utensil to follow the extent of the extension element. That will be the cut line. The user will then keep the rear end of the apparatus abutted to the fixed structure but move it to the opposite end of the uncut tile from where the initial mark was made. The user will make a mark at this edge of the uncut tile at the point where the extension element ends. Again, the user will draw a line that follows the line of the extension element. By using the method and apparatus of the present invention, the cut line for tile cutting will be exactly catered to the unique contours and conditions of a fixed structure during the tile setting process. This means that if a fixed structure is crooked or uneven in some way, the present invention provides a fixed measurement to reflect these conditions.

### BRIEF DESCRIPTION OF THE PREFERRED EMBODIMENT

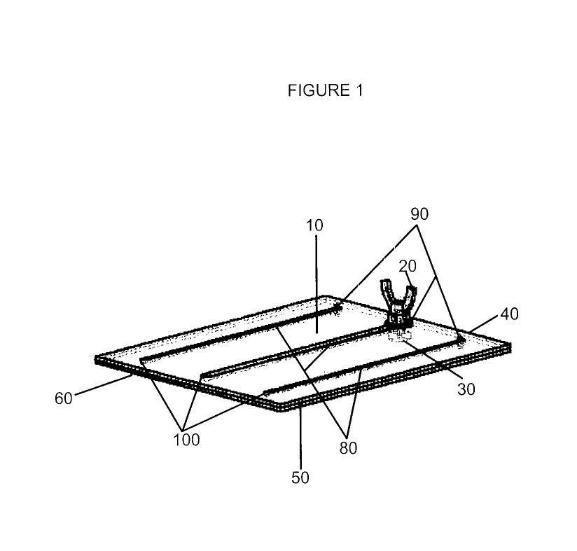

FIG. 1 is a view of the apparatus of the present invention in a retracted phase.

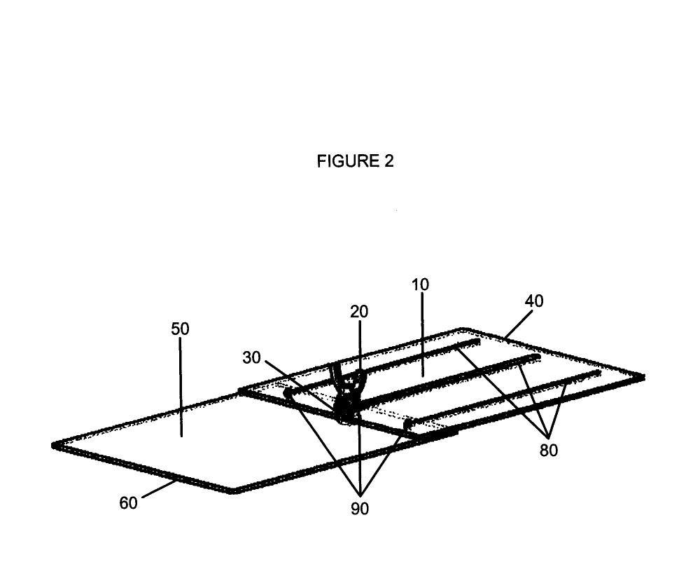

FIG. 2 is a view of the apparatus of the present invention in an extended phase.

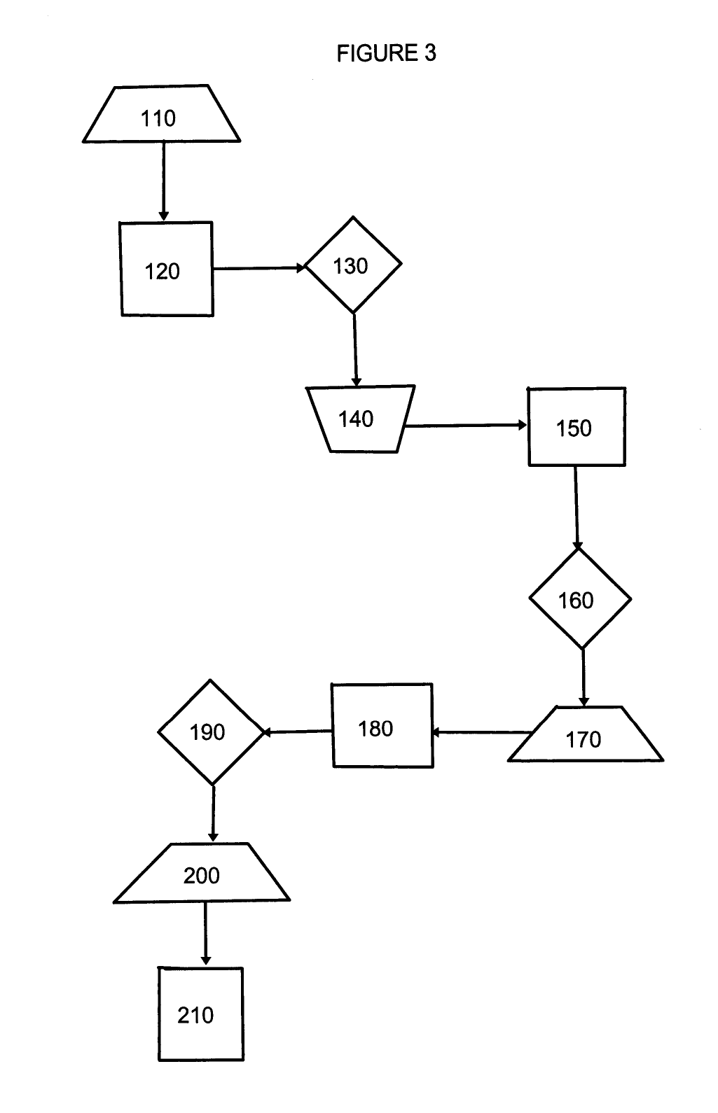

FIG. 3 is a flow chart of the method of use in regard to the present invention

### DETAILED DESCRIPTION OF THE PRESENT INVENTION

I. The Parts

We see in FIG. 1 the apparatus of the present invention while the extension element (50) is not in use. Most elements of the apparatus of the present invention consist of a sturdy material such as plastic. Based on this type of material, the apparatus of the present invention maintains long-lasting durability because it will not rust or deteriorate through repeated use, as would a tape measure or other such measuring tool. Although most elements of the apparatus of the present invention elements are made of this material, an exception in some embodiments may be the wing nut (20) and locking mechanism (30).

When the extension element of the present invention is not in use, it is placed directly under the body (10) of the apparatus of the present invention. The extension element (50) is connected to the body (10) at connection points (90) toward the rear end (40) of the apparatus of the present invention. The extension element (50) is locked into its retracted place at one of the connection points (90) through the locking mechanism (30) that is also located toward the rear end (40) of the apparatus of the present invention. The wing nut (20) is connected to the locking mechanism (30), which is conventional in nature. When a user loosens the wing nut (20) in a conventional manner, the locking mechanism (30) will release its hold on the extension element (50) at that particular connection point (90). Once the wing nut (20) is loosened, the extension element (50) may be extended.

In FIG. 2, we see a view of the apparatus of the present invention where the extension element (50) is extended to its farthest point. The reason the extension element (50) is extended is because the wing nut (20) had been loosened so that the locking mechanism (30) was released. Once the hold from the locking mechanism (30) was released, the extension element (50) could be pulled outward while still maintaining a connection to the body (10) through the connection points (90). In one embodiment of the present invention, the connection points (90) could be plastic posts that have been formed as part of the extension element (50). These connection points (90), as well as the loosened wing nut (20) and released locking mechanism (30) then can be pulled outward along with the extension element (50). These elements move outward along the extension element tracks (80). When a user pulls the extension element (50) in order to extend the apparatus of the present invention, the connection points (90) in communication with the extension element (50) slide along the extension element tracks (80). As we see in FIG. 2, the extension element can be pulled out and away from the body (10) of the apparatus until the connection points (90) reach the extension element track edges (100). At the extension element track edges (100), there is no more distance that the extension element (50) via the connection points (90) may travel.

In FIG. 2, we see the extension element pulled completely out and only stopped after the connection points (90) reached the extension element track edges (100). However, at any point during the outward pulling of the extension element (50), a user can tighten the wing nut (20). Regardless of its position on the extension element tracks (80), the wing nut (20) may be tightened. When the wing nut (20) is tightened, the locking mechanism (30) will lock the extension element (50) at that exact location. This means that if the connection points (90) are pulled 5″ outward down the extension element tracks (80), then that precise location is where the extension element (50) and its corresponding connection points (90) will be locked into place as the locking mechanism (30) regains its locking grip on that particular connection point (90).

In FIG. 1 and FIG. 2, we see the apparatus of the present invention in its primary states of use. In FIG. 1 and FIG. 2, we also see the rear end (40) of the apparatus. The rear end (40) is the location where the apparatus of the present invention abuts or meets a fixed structure such as a wall or cabinet. The rear end (40) can be placed on all types of conditions including uneven, diagonal fixed structures. Meanwhile, in FIG. 1 and more prominently in FIG. 2, we see the extension element outward edge (60). The extension element outward edge (60) is the element of the apparatus of the present invention where a user may mark a cut line along the straight line of the extension element outward edge (60). The extension element outward edge (60) is used and effective when the apparatus of the present invention is locked into place through the tightening of the wing nut (20).

II. The Usage

The apparatus of the present invention is essentially a tool to provide efficient, cost-effective and user-friendly assistance during the vitally important task of determining where exactly a cut line should be when setting tile. The apparatus does not use numbers and does not require measurements to be taken. Instead, the apparatus of the present invention locks into place the exact lines and consequently markings where tile should be cut. These cut lines gleaned from the present invention will conform to the unique and potentially uneven contours of a fixed structure. In FIG. 3, we see a flow chart of a step-by-step process the present invention undertakes in terms of the method and apparatus to provide for a perfect and efficient cut.

The first step is to lay full tile (110). Oftentimes, people who set tile will begin at a point in the room such as the middle and work from there. But because rooms are almost never in perfect proportion to the dimensions of the individual tiles, it is inevitable that tile will need to be cut. The most obvious area where cut tile is set is in relation to fixed structures such as walls and cabinets. After the user lays full tile (110), the user will then place a first piece of tile and a second piece of tile flat onto a table next to each other (120). When doing this, the user should ensure that a spacer is inserted (130) between the first piece of tile and the second piece of tile to account for the grout line. The next step is locking the present invention in place (140). As mentioned in FIG. 1 and FIG. 2, the wing nut (20) is conventionally loosened in order to move the extension element (50). The extension element (50) is extended in the manner described in FIG.1 and FIG. 2 so that one end of the present invention is lined up with the edge of the second piece of tile as referenced in 120, and the extension element (50) is lined up with the outside edge of the spacer that had been inserted as referenced in 130. The wing nut (20) is conventionally tightened which locks the extension element (20) in place. By locking the present invention in place (140), the present invention is set at the proper distance and is now ready to tailor a third tile piece for cutting based on the contours of the fixed structure.

After locking the present invention in place (140) through the functions described in FIG. 1 and FIG. 2, user places the third tile piece, which is uncut, over an already set tile that also is uncut (150). The already set tile is the one that is in front of the cut area and already set. The user must ensure that the third tile is resting exactly over the already set tile with all edges lined up. Then, the rear end of the present invention is abutted against a fixed structure (160). The user will then mark, using a conventional writing utensil, a first part of a cut line (170) at an edge of the third tile where the extension element edge is located. That will be the first part of the cut line.

Depending upon the size of the third tile, it may be necessary to slide the present invention along the fixed structure (180) to determine other parts of the cut line. For example, if a tile is 2′ wide, and the present invention is only 1′ wide, then a cut line will have a first part and a second part. This is because the present invention is only 1′ wide, and thus the cut line can only be marked 1′ at a time.

The process of sliding the present invention along the fixed structure (180) also will account for variations in the dimensions of the fixed structure as applied to the width of the tile. In other words, two fixed structures such as two opposite walls of a room are oftentimes not constructed parallel to one another, thus as the present invention is slid along the fixed structure, the present invention will capture the angle of the fixed structure relative to an opposite fixed structure. This is because when tiles are laid between two fixed structures, the tiles are laid flush against one of the fixed structures. When tiles are laid end-to-end from one of the fixed structures, the portion of a tile necessary to meet the opposite fixed structure is not consistent unless the two fixed structures are exactly parallel.

The user will make another mark (190) at second part of the third tile at the point where the extension element ends. Again, the user will draw a line that follows the line of the extension element. By using the method and apparatus of the present invention, the cut line for tile cutting will be exactly catered to the unique contours and conditions of the fixed structure during the tile setting process. This means that if a fixed structure is crooked or uneven in some way, the present invention provides a fixed measurement to reflect these conditions. Once the user makes another mark (190) and determines the cut line, user may move on to a next tile (200) in order to determine that tile's cut line in relation with that portion of the fixed structure and all the unique contours included from that particular location. When the user is ready, he or she may then place the third tile in a cutter (210) based on the cut line gleaned from the present invention. After cutting the tile, the user may then set the third tile (220).

The apparatus of the present invention provides an exact location to mark the cut line on tile designated for setting next to fixed structures. The present invention accounts for the inherent unevenness and other deficiencies involved in setting and cutting tile to conform to the fixed structures. The present invention has additional benefits of cost efficiency because it provides an accurate cut line as opposed to trial and error.

The present invention allows for capturing the size of a tile and calculating the distance and angle between a fixed structure, such as a wall or cabinet, and the edge of the last uncut tile laid on a floor, for example. Once the distance is ascertained, the user can then cut the tile to exactly equal that distance and angle.

The present invention is more than merely the embodiments of described above, and is all embodiments within the scope of the following claims.

I claim:

1. A method for working with tile, comprising:
calculating the length of a tile and a spacer;
placing an uncut tile atop a closest laid tile to a fixed structure; and
marking the length of the tile and the spacer on the uncut tile so that the length of the tile and the spacer has one end point at the fixed structure and a second endpoint atop the uncut tile to create a cut line.

2. The method of claim 1, further comprising cutting the uncut tile along the cut line.

3. The method of claim 1, wherein calculating the length of a tile and a spacer is done via two plates that extend from one another.

4. The method of claim 1, wherein calculating the length of a tile and a spacer is done via a first plate and a second plate that slide together.

5. The method of claim 1, wherein calculating the length of a tile and a spacer is done via two flat edges that are configured to move apart from one another.

6. The method of claim 5, wherein the two flat edges are configured to move apart from one another via at least one track.

7. The method of claim 1, further comprising using a flat-edged device for said marking the length of the tile and the spacer on the uncut tile so that the length of the tile and the spacer has one end point at the fixed structure and a second endpoint atop the uncut tile to create a cut line.

8. The method of claim 1, further comprising using two plates that extend from one another for said marking the length of the tile and the spacer on the uncut tile so that the length of the tile and the spacer has one end point at the fixed structure and a second endpoint atop the uncut tile to create a cut line.

9. The method of claim 1, further comprising using a first plate and a second plate that slide together for said marking the length of the tile and the spacer on the uncut tile so that the length of the tile and the spacer has one end point at the fixed structure and a second endpoint atop the uncut tile to create a cut line.

10. The method of claim 1, further comprising using two flat edges that are configured to move apart from one another for said marking the length of the tile and the spacer on the uncut tile so that the length of the tile and the spacer has one end point at the fixed structure and a second endpoint atop the uncut tile to create a cut line.

11. The method of claim 10, wherein the two flat edges are configured to move apart from one another via at least one track.

12. The method of claim 2, wherein calculating the length of a tile and a spacer is done via two plates that extend from one another.

13. The method of claim 2, wherein calculating the length of a tile and a spacer is done via a first plate and a second plate that slide together.

14. The method of claim 2, wherein calculating the length of a tile and a spacer is done via two flat edges that are configured to move apart from one another.

15. The method of claim 14, wherein the two flat edges are configured to move apart from one another via at least one track.

16. The method of claim 2, further comprising using a flat-edged device for said marking the length of the tile and the spacer on the uncut tile so that the length of the tile and the spacer has one end point at the fixed structure and a second endpoint atop the uncut tile to create a cut line.

17. The method of claim 2, further comprising using two plates that extend from one another for said marking the length of the tile and the spacer on the uncut tile so that the length of the tile and the spacer has one end point at the fixed structure and a second endpoint atop the uncut tile to create a cut line.

18. The method of claim 2, further comprising using a first plate and a second plate that slide together for said marking the length of the tile and the spacer on the uncut tile so that the length of the tile and the spacer has one end point at the fixed structure and a second endpoint atop the uncut tile to create a cut line.

19. The method of claim 2, further comprising using two flat edges that are configured to move apart from one another for said marking the length of the tile and the spacer on the uncut tile so that the length of the tile and the spacer has one end point at the fixed structure and a second endpoint atop the uncut tile to create a cut line; the two flat edges are configured to move apart from one another via at least one track.

20. A method for working with tile, comprising:
calculating the length of a tile and a spacer;
placing an uncut tile atop a closest laid tile to a fixed structure;
marking the length of the tile and the spacer on the uncut tile so that the length of the tile and the spacer has one end point at the fixed structure and a second endpoint atop the uncut tile to create a cut line;
cutting the uncut tile along the cut line;
calculating the length of a tile and a spacer is done via two plates that extend from one another;
wherein calculating the length of a tile and a spacer is done via a first plate and a second plate that slide together;
wherein calculating the length of a tile and a spacer is done via two flat edges that are configured to move apart from one another;
wherein the two flat edges are configured to move apart from one another via at least one track;
further comprising using a flat-edged device for said marking the length of the tile and the spacer on the uncut tile so that the length of the tile and the spacer has one end point at the fixed structure and a second endpoint atop the uncut tile to create a cut line;
further comprising using two plates that extend from one another for said marking the length of the tile and the spacer on the uncut tile so that the length of the tile and the spacer has one end point at the fixed structure and a second endpoint atop the uncut tile to create a cut line;
further comprising using a first plate and a second plate that slide together for said marking the length of the tile and the spacer on the uncut tile so that the length of the tile and the spacer has one end point at the fixed structure and a second endpoint atop the uncut tile to create a cut line;
further comprising using two flat edges that are configured to move apart from one another for said marking the length of the tile and the spacer on the uncut tile so that the length of the tile and the spacer has one end point at the fixed structure and a second endpoint atop the uncut tile to create a cut line;
wherein the two flat edges are configured to move apart from one another via at least one track;
wherein calculating the length of a tile and a spacer is done via two plates that extend from one another;
wherein calculating the length of a tile and a spacer is done via a first plate and a second plate that slide together;
wherein calculating the length of a tile and a spacer is done via two flat edges that are configured to move apart from one another;
wherein the two flat edges are configured to move apart from one another via at least one track;
further comprising using a flat-edged device for said marking the length of the tile and the spacer on the uncut tile so that the length of the tile and the spacer has one end point at the fixed structure and a second endpoint atop the uncut tile to create a cut line;
further comprising using two plates that extend from one another for said marking the length of the tile and the spacer on the uncut tile so that the length of the tile and the spacer has one end point at the fixed structure and a second endpoint atop the uncut tile to create a cut line;
further comprising using a first plate and a second plate that slide together for said marking the length of the tile and the spacer on the uncut tile so that the length of the tile and the spacer has one end point at the fixed structure and a second endpoint atop the uncut tile to create a cut line; and
further comprising using two flat edges that are configured to move apart from one another for said marking the length of the tile and the spacer on the uncut tile so that the length of the tile and the spacer has one end point at the fixed structure and a second endpoint atop the uncut tile to create a cut line; the two flat edges are configured to move apart from one another via at least one track.
